(19) United States
(12) Patent Application Publication
(10) Pub. No.: US 2020/0063907 A1
(43) Pub. Date: Feb. 27, 2020

(54) Plug Connector

(71) Applicants: Yves CHRISTMANN, Briey (FR); NORMA Germany GmbH, Maintal (DE)

(72) Inventor: Yves Christmann, Briey Cedex (FR)

(21) Appl. No.: 16/462,750

(22) PCT Filed: Nov. 16, 2017
(86) PCT No.: PCT/EP2017/079405

§ 371 Date: May 21, 2019

(30) Foreign Application Priority Data
Nov. 21, 2016 (DE) 10 2016 122 319.0

(51) Int. Cl. F16L 53/35; F16L 33/035; F16L 33/30

(52) U.S. Cl. CPC F16L 53/35; F01N 3/0842; F16L 33/30; F16L 33/035

(57) ABSTRACT

A plug connector comprising a housing that has a channel which extends from a first end of the housing to a second end of the housing. A connection piece is provided on the first end and a connection geometry is provided on the second end. A heating zone is provided inside the channel. A heat-conducting element is arranged between the heating zone and the second end. The heat-conducting element has a heat-output section which is in the form of a cylindrical sleeve that surrounds the internal space. The cylindrical sleeve has a peripheral wall that is closed in the peripheral direction.

### INTRODUCTION

The disclosure relates to a plug connector.

Such plug connectors are used for example for fluid lines in automobiles to connect a reservoir to a point of consumption via a fluid line. However, various line sections of the fluid line can also be connected to one another by the plug connector. The plug connector has a connection fitting onto which a line, for example a hose or a tube, can be pushed and optionally fixed thereon. At the opposite end, a connection geometry for connection to a line or a reservoir is provided. A channel for the fluidic connection of the connection fitting and the connection geometry is provided between the ends of the housing.

For example, urea is transported from a reservoir to a point of consumption via the fluid line. The urea is required, for example, for exhaust gas aftertreatment in diesel engines to reduce the nitrogen oxides contained in the exhaust gas. The urea loses its flowability at a temperature below −11° C. To also ensure the exhaust gas aftertreatment at low temperatures, it can be necessary to make sure that the temperature in the urea line during operation is above −11° C. Furthermore, when starting an engine at low temperatures, the urea line must be defrosted within a defined time period, specified according to regulations, so that the urea can be used for the exhaust gas aftertreatment.

To ensure the flowability of the urea and therefore the exhaust gas aftertreatment or to enable rapid defrosting of a urea line, a heating zone is provided, which can heat the channel or the fluid flowing through the channel. A heating element is provided in the heating zone, which heating element is guided through the connection fitting and can extend into the line connected to the connection fitting. To connect the heating element to an energy supply, for example an electrical energy supply, it is often necessary to lead the heating element out of the plug connector.

A heatable fluid line coupling is disclosed in DE 10 2007 036 533 A1. The fluid line coupling comprises a receiving part, a connection and a heating element arranged between the receiving part and the connection. A contact region between the heating element and fluid line interior can be formed by a hollow-cylindrical fluid-contact sleeve.

WO 2009/013342 A2 discloses a line connector and a media line, which can both be heated by a heating wire wound around inner line walls.

A heatable media line is disclosed in DE 10 2008 018 658 A1. A heating wire extends within the media line, surrounded by a heat-conductive molded body. The heating wire can be led out of the media line through a separate connection housing.

A plug connector and a heatable media line are disclosed in FR 2 924 786 A1. A heating wire is arranged on an outer side of the plug connector or the media line.

WO 02/38426 A1 discloses a distributor having two fluid connections and a separate connection for a heating wire. In this case, the heating wire extends loosely within the distributor.

### SUMMARY

An object of the disclosure is to provide a plug connector of the type mentioned at the outset, which enables rapid heating of the fluid line or the fluid to be transported in the fluid line.

In an embodiment, a plug connector having a housing, which has a channel which extends from a first end of the housing to a second end of the housing, wherein a connection fitting is provided on the first end and a connection geometry is provided on the second end, wherein a heating zone is provided in the interior of the channel, wherein a heat-conducting element is arranged between the heating zone and the second end, wherein the heat-conducting element has a heat-output portion which is formed as a cylinder sleeve which surrounds an interior space, it is provided that the cylinder sleeve has a circumferential wall which is closed in the circumferential direction.

To achieve rapid defrosting of the urea in an embodiment, it is desirable to heat the fluid volume present in the plug connector as fully as possible. However, it is relatively difficult to arrange a heating element such that it can heat this liquid volume directly. Therefore, to heat the fluid volume, a heat-conducting element is provided, which is in heat-conducting contact with the heating zone. The heat-conducting element absorbs the heat from the heating zone and conducts it to the heat-output portion. Therefore, the fluid flowing into the channel can already be heated before it flows into the heating zone. In conjunction with the heating zone, a very large area is therefore available in which the fluid can be heated, so that effective heating of the fluid can be achieved. All in all, all the fluid present in the plug connector is heated so that urea which is present in the plug connector, for example, can be heated rapidly to a flowable temperature.

In this case, it is unnecessary for the heat-conducting element to be able to generate heat itself. The heat-conducting element must simply be capable of transporting heat from the heating zone into the channel with the smallest losses possible. The design of a heat-conducting element and the construction of a plug connector with such a heat-conducting element are thus very simple because the heat-conducting element itself does not require any connections via which electrical energy can be supplied, for example.

Moreover, the heat-conducting element has a heat-output portion, which is formed as a cylinder sleeve, which surrounds an interior space in which the channel is partially formed. In this case, the cylinder sleeve can be based at least partially on a circular cylinder. However, any other cross-sections are possible. Since the channel extends through the cylinder sleeve and is fully surrounded by this as a result of the circumferential wall which is closed in the circumferential direction, the fluid flowing through the cylinder sleeve is fully heated. The surface via which heat can be transferred is therefore kept as large as possible.

The heat-conducting element preferably extends into the connection geometry. The heat from the heat-conducting element is therefore transported not only into the channel, but to the second end. A relatively long length is thus available, via which the heat-conducting element can output heat to the liquid in the channel.

The heat-conducting element can have a fastening portion, which is plugged into the channel. The fastening portion is used to fasten the heat-conducting element in the housing. To this end, it is fastened in the channel.

The heat-conducting element can have, along its length, an external dimension which is maximally the same size as the internal dimension of the channel.

The heat-conducting element can be held in the channel in a clamping manner. The heat-conducting element can thus be adequately fastened in the housing. Further fastening devices are unnecessary.

The heat-conducting element can be formed from a metal, in particular aluminum, copper or brass. Metal is a relatively good heat conductor. It is possible to select a metal so that it readily tolerates the liquid be heated. The heat-conducting element can also be formed from a plurality of metals. For example, the heat-conducting element can be designed to be multi-layered or coated. Therefore, silver-plated copper can also be used, for example.

A heating element can be arranged in the heating zone and the heat-conducting element is in heat-conducting contact with the heating element. This improves the heat transfer. The heat-conducting element can assume the temperature of the heating element at any point in which it is in heat-conducting contact with the heating element, the temperature of the heating element generally being higher than the temperature of the liquid in the heating zone at a certain distance from the heating element. This further improves the heat transport from the heating element into the channel.

In this case, the heat-conducting element can be connected to the heating element in a clamping manner. If the heat-conducting element is connected to the heating element in a clamping manner, then it abuts against the heating element with a certain tension. This improves the heat transfer between the heating element and the heat-conducting element.

A ramp element can furthermore be arranged in the channel, along which ramp element the heating element is led out of the channel, wherein the heat-conducting element has a recess which receives the ramp element. The heat-conducting element can then be guided around the ramp element, as it were, so that it can be introduced a relatively long way into the heating zone in spite of the ramp element and can be connected to the heating element in a clamping manner.

The housing can have a movable locking geometry and the heat-conducting element projects into a region in which the locking geometry is arranged. The locking geometry serves for example to secure a fitting and release it, possibly following a movement of the locking geometry, so that the plug connector can be removed from the fitting. Since the locking geometry acts on the fitting, it is ensured that the heat-conducting element can project into the interior of the fitting when it projects into the region in which the locking geometry is arranged. The heating of the interior space of the fitting can then also be ensured if a sealing arrangement is arranged in another position and the heat-conducting element does not reach into the region of the sealing arrangement. In the case of such a locking geometry, it is, for example, not possible to arrange a heating device, for instance a heating wire, on the outside of the housing.

The connection geometry can have a fitting, for example.

Alternatively, the connection geometry can also have receiving space for a fitting.

### BRIEF DESCRIPTION OF THE FIGURES

Further features, details and advantages of the disclosure are revealed in the wording of the claims and in the description below of embodiments with reference to the drawings, which show:

FIG. 1. a perspective view of a plug connector;

FIG. 2. a sectional view through the plug connector of FIG. 1;

FIG. 3. a plan view of the plug connector of FIG. 1; and

FIG. 4. a plan view of the connection fitting of the plug connector of FIG. 1.

### DETAILED DESCRIPTION

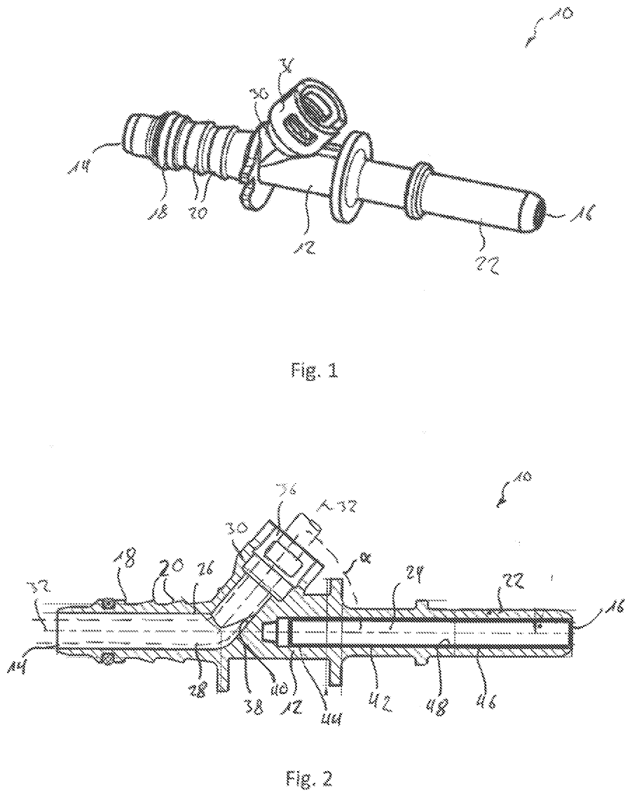

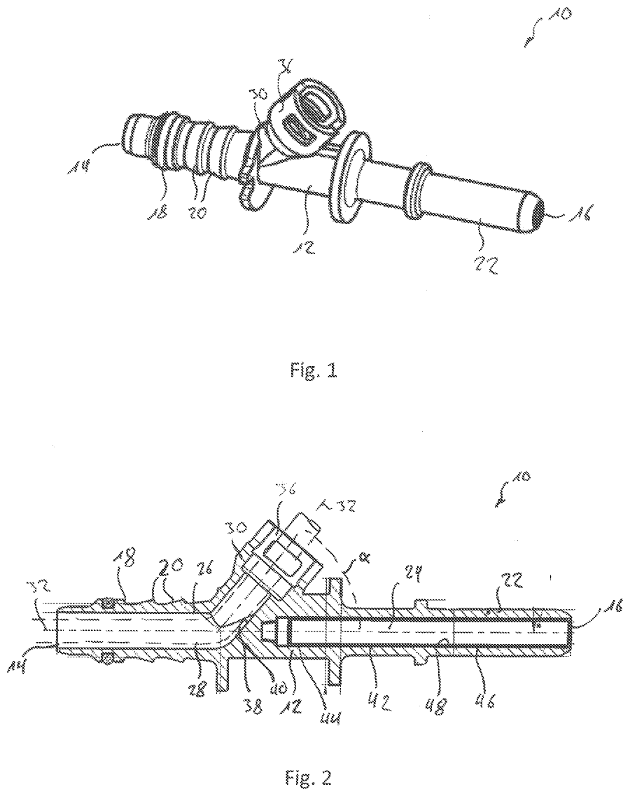

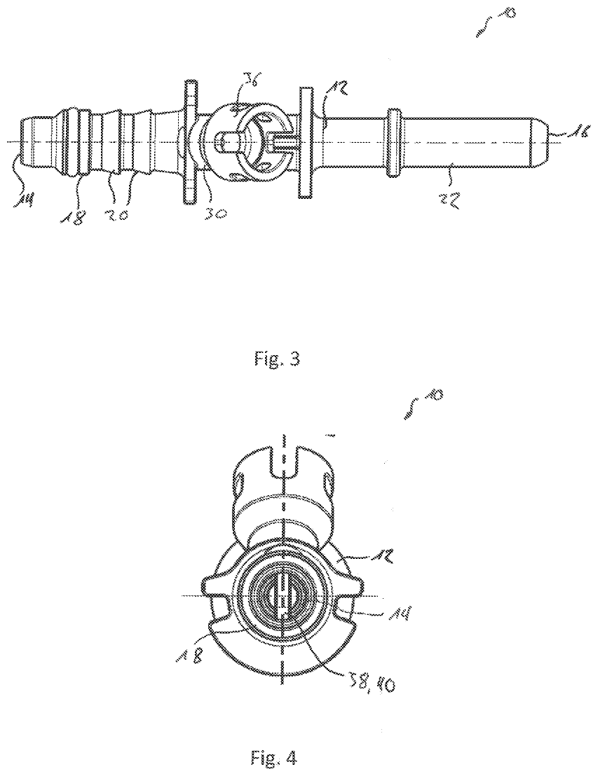

In FIGS. 1 to 4, an embodiment of a plug connector 10 for a fluid line, for example a urea line in a vehicle, is shown. Such a urea line guides urea from a reservoir to a consumer. The urea is used in a diesel engine for exhaust gas aftertreatment to reduce nitrogen oxide emissions. The plug connector 10 can connect a line section of the urea line to the consumer or to the reservoir. However, the plug connector can also connect two line sections of the urea line to one another.

The plug connector 10 has a housing 12 with a first end 14 and a second end 16. The first end 14 has a connection fitting 18, which has a fir-tree profile 20 on its outer side, by means of which a hose or a tube pushed onto the connection fitting 18 is prevented from slipping. The hose or tube can be flexibly designed. On the outside, the hose or tube can be additionally fastened to the connection fitting 18 by a tensioning element.

The second end 16 likewise has a connection geometry 22 which is formed as a connection fitting and onto which a hose or a tube can be pushed. Alternatively, the connection geometry 22 can also have a receiving space for a connection fitting of a line section, for example.

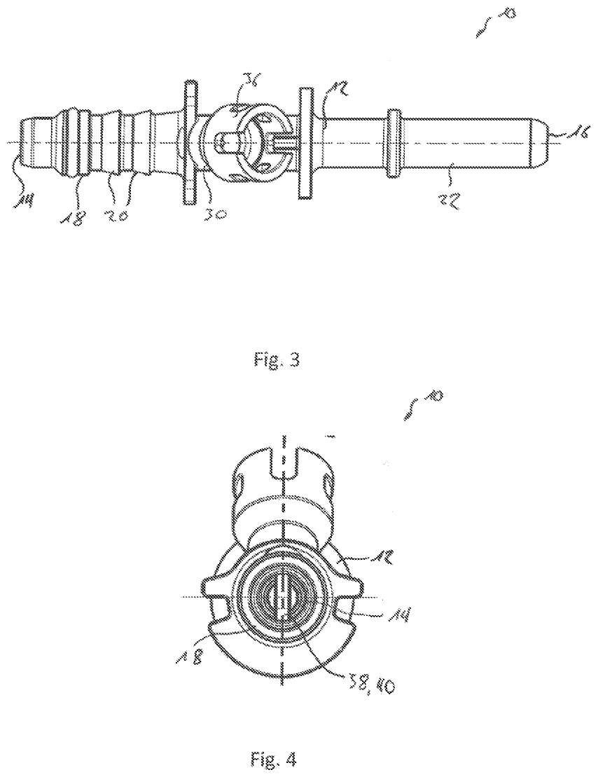

As can be seen in particular in FIG. 2, the ends 14, 16 are connected by a channel 24 so that a fluid can flow between the ends 14, 16. For example, the second end 16 is connected to a reservoir or a line section connected to the reservoir and the first end 14 is fluidically connected to a consumer or a line section connected to the consumer.

A heating zone 26 is provided in the channel, in which heating zone a heating element 28 is provided, as can be seen in FIG. 2. The heating element 28 in the present case is a flexible heating rod, which has at least one heating conductor which is embedded in an extruded plastics material. Two heating conductors can be provided, which are connected to one another at an end which is remote from the plug connector 10 so that an electrical connection is only necessary at one end of the heating element 28. Although the heating element 28 is flexible and bendable, it has a certain inherent rigidity so that the heating element 28, when a line section (with a heating element located therein) is pushed onto the connection fitting 18, the heating element 28 can be pushed into the connection fitting 18.

The heating element 28 must be led out of the plug connector 2 so that electrical connections (not illustrated in more detail) can be established, via which the designed heating power can be introduced into the heating element 28. Accordingly, the plug connector 10 has a heating-element exit channel 30, whereof the longitudinal axis 32 is at an angle α to the longitudinal axis 34 of the plug connector 10. The angle α is greater than 0° and is preferably in the range of 20° to 80°.

The heating-element exit channel 30 is arranged in a fitting 36 which is aligned at the angle α to the longitudinal axis 34 of the plug connector 10. An O-ring (not illustrated here) can be provided in the fitting 36, which O-ring abuts against the heating element 28 in a sealing manner and prevents fluid from exiting out of the heating-element exit channel 30. The O-ring is secured in the heating-element exit channel 30 with the aid of a plug.

A ramp element 38, which is integrally formed with the housing 12, is arranged in the channel 24. The ramp element 38 has a guide surface 40 which is curved, i.e. formed without kinks. The guide surface 40 extends from the “underside” of the channel 24, i.e. the side opposite the heating-element exit channel 30, to the heating-element exit channel 30 and continues in a wall of the heating-element exit channel 30. The tip of the heating element 28 can therefore slide along the guide surface 40 without being impeded by steps, kinks, grooves or the like. If the heating element 28 is pushed into the channel 24, a front end comes into contact with the guide surface 40 and is deflected by this as the heating element 28 is pushed further into the heating-element exit channel 30 so that the heating element 28 can exit out of the heating-element exit channel 30 and be connected to an energy supply.

A fluid flowing through the channel 24 can be heated by the heating element 28. The heating zone 26 is defined as the region in which the heating element 28 can heat the fluid in the channel 24. Accordingly, the heating zone 26 in the channel 24 extends from the first end 14 to the ramp element 38.

A heat-conducting element 42 is furthermore provided in the channel 24, which heat-conducting element extends from the second end 16 to the ramp element 38 or to the heating element 28. The heat-conducting element 42 consists of a heat-conducting material, for example a highly heat-conductive metal such as aluminum, copper, brass or a metal alloy.

The heat-conducting element 42 has a fastening portion 44, with which the heat-conducting element can be plugged into the channel 24 and fastened therein. The external dimensions of the fastening portion 44 along the length of the heat-conducting element 42 can be maximally the same size as the internal dimension of the channel 24, so that the heat-conducting element is held in the channel 24 in a clamping manner. The fastening portion 44 can have for example a recess extending the longitudinal direction from one end so that the fastening portion 44 can be pushed into the channel 24 on both sides of the ramp element 38, whereby it is pushed past the ramp element 38 to the heating element 28.

In a manner not illustrated in more detail, the fastening portion 44 has a geometry which is adapted to the geometry of the heating element 28 in the region of the ramp element 38 so that the fastening portion 44 can be clamped on the heating element 28. The heat-conducting element 42 is then in heat-conducting communication with the heating element 28 so that heat from the heating element 28 can be transferred to the heat-conducting element 42.

The heat-conducting element 42 furthermore has a heat-output portion 46 which is formed as a cylinder sleeve and projects into the connection geometry 22. The cylinder sleeve can be a circular cylinder. The cylinder sleeve has a circumferential wall 48 which is fully closed in the circumferential direction. In the circumferential direction, the the heat-output portion 46 abuts circumferentially against the channel inside wall by means of the circumferential wall 48 and thus forms the channel 24 in sections. Since the heat-conducting element 42 is connected to the heating element 28 in a heat-conducting manner, heat from the heating element 28 is conducted into the heat-conducting element 42 so that it is heated. The heat-output portion 46 can output the heat to a fluid flowing in via the second end 16 so that this fluid is heated.

The heat-output portion 46 is fully closed in the circumferential direction, particularly good heat transfer to the fluid is possible. The fluid flows past the heat-transfer element 42 or through this so that the fluid is reliably heated.

In combination with the heating element 28, heating of the fluid thus take place in the whole of the channel 24. To this end, the heat-output portion 46 extends to the second end 16.

The invention is not restricted to one of the embodiments described above, but can be modified in a variety of ways. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

LIST OF REFERENCE SIGNS
10 Plug connector
12 Housing
14 First end of the housing
16 Second end of the housing
18 Connection fitting
20 Fir-tree profile
22 Connection geometry
24 Channel
26 Heating zone
28 Heating element
30 Exit channel
32 Longitudinal axis
34 Longitudinal axis
36 Fitting
38 Ramp element
40 Guide surface
42 Heat-conducting element
44 Fastening portion
46 Heat-output portion
48 Circumferential wall

1. A plug connector having a housing, which has a channel which extends from a first end of the housing to a second end of the housing, wherein a connection fitting is provided on the first end and a connection geometry is provided on the second end, wherein a heating zone is provided in the interior of the channel, wherein a heat-conducting element is arranged between the heating zone and the second end, wherein the heat-conducting element has a heat-output portion which is formed as a cylinder sleeve which surrounds an interior space, wherein the cylinder sleeve has a circumferential wall which is closed in the circumferential direction.

2. The plug connector as claimed in claim 1, wherein the heat-conducting element extends into the connection geometry.

3. The plug connector as claimed in claim 1, wherein the heat-conducting element has a fastening portion which is plugged into the channel.

4. The plug connector as claimed in claim 1, wherein the heat-conducting element has, along its length, an external dimension which is maximally the same size as the internal dimension of the channel.

5. The plug connector as claimed in claim 1, wherein the heat-conducting element is held in a clamping manner.

6. The plug connector as claimed in claim 1, wherein the heat-conducting element is formed from aluminum, copper or brass.

7. The plug connector as claimed in claim 1, wherein a heating element is arranged in the heating zone and the heat-conducting element is in heat-conducting contact with the heating element.

8. The plug connector as claimed in claim 7, wherein the heat-conducting element is connected to the heating element in a clamping manner.

9. The plug connector as claimed in claim 7, wherein a ramp element is arranged in the channel, along which ramp element the heating element is led out of the channel, wherein the heat-conducting element has a recess which receives the ramp element.

10. The plug connector as claimed in claim 1, wherein the housing has a locking geometry and the heat-conducting element projects into a region in which the locking geometry is arranged.

11. The plug connector as claimed in claim 1, wherein the connection geometry has a fitting.

12. The plug connector as claimed in claim 1, wherein the connection geometry has a receiving space for a fitting.
